(19) United States
(12) Patent Application Publication
(10) Pub. No.: US 2003/0229896 A1
(43) Pub. Date: Dec. 11, 2003

(54) Decision fusion of recommender scores through fuzzy aggregation connectives

(75) Inventor: Anna L. Buczak, Briarcliff Manor, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/165,932

(22) Filed: Jun. 10, 2002

(51) Int. Cl. H04N 5/445

(52) U.S. Cl. 725/46

(57) ABSTRACT

A method of fusing recommender scores includes the steps of: (a) providing a first recommender score for a topic of interest based on a first set of information; (b) providing a second recommender score for the topic of interest based on a second set of information; (c) fusing the first recommender score and the second recommender score by compensatory fuzzy aggregation connectives; and (d) providing a final recommendation for the topic of interest based on the fusion in step (c). The method may include providing at least a third recommender score, and step (c) includes fusing the third recommender score with the first recommender score and the second recommender score. The final recommendation can be output on one of a display unit and a television set. The compensatory fuzzy aggregation connectives used for fusing in step (c) may include a Generalized Mean or a Gamma Model. The first and second recommender scores, while related to same topic, could be scores for different people, such as a couple watching television.

### BACKGROUND OF THE INVENTION

1. Field of the Invention

The present invention relates to methods for recommending items of interest such as TV shows. More particularly, the present invention relates to the decision-level fusion of television recommender scores from a plurality of recommenders using fuzzy aggregation connectives.

2. Description of the Related Art

Prior art television recommender systems generate recommendations for a viewer based on viewer's explicit preferences, or his/her implicit preferences as inferred from viewing history.

For example, explicit recommenders are based on user definitions of the television programs that the particular user shows interest in. In other words, the user actively provides preferences such as channel, genre, title to a television recommender system. There are also implicit recommenders, which infer knowledge about user preferences based on shows that the user actually watched, or did not watch. It is known in the art to use techniques for generating recommendations based on viewing history, such as explicit, implicit Bayesian, implicit Decision Trees, and nearest neighbor classifiers.

A combination of implicit Bayesian, implicit Decision Tree and explicit recommenders through voting techniques has also been proposed in the art (see Combination of Implicit and Explicit Scores of the Recommender Through Voting, by S. Gutta, K. Kurapati, and D Schaffer, U.S. Ser. No. 09/821,277, filed Mar. 27, 2001, the contents of which are hereby incorporated by reference as background material).

Recommender systems can analyze the content, or descriptions of the content of a program or show based on its meta-data and produce recommendation scores. A recommendation score, which is an estimation of the content appreciation by the user, can be used to compile recommendation lists, or for actions such as automatic recording. It has been observed that different recommendation tools will generally provide somewhat different recommendations for the same data set, such as a listing of the available programs for a given week. The differences in the generated recommendations are due to the different recommendation tools using different, often complementary, information. For example, the explicit information obtained from a given user is substantially different from the implicit information established from the user's viewing history.

Additionally, different recommendation mechanisms typically have their own biases that affect the final recommendations. Combining the recommendation scores from different recommenders could enhance the recommendation made to a user. Accordingly, there is a need in the art for fusion of recommenders from a plurality of different television recommenders to enhance the selections suggested to a user, by making the recommenders base the suggestion on more human-like decision making. Moreover, there is also a need in the art to suggest specific fuzzy aggregation connectives for performing fusion of recommenders as a way to combine several recommendations, which is heretofore unknown in the art.

### SUMMARY OF THE INVENTION

The present invention discloses a method and system for fusion of television recommenders heretofore unknown in the prior art. In the present invention, a plurality of fuzzy aggregation connectives are used to perform the fusion of recommenders for providing an enhanced efficiency for coming up with final recommendations of items such as TV shows, books to buy/read, movies to watch, etc.

According to the present invention, compensatory fuzzy aggregation connectives are used for fusing recommendations from individual recommender engines. Use of compensatory fuzzy aggregation connectives for emulating the human decision making process, yields good results due to the mathematical properties of those connectives that imitate the tendency of humans to compensate attribute deficiencies of one aspect by stressing certain attributes of another aspect.

As described in more detail, the present invention performs a series of recommendations using fuzzy aggregation connectives to offer a more flexible way of performing fusion of recommendations heretofore unknown in the art. These connectives permit a position between the union and intersection of different recommenders. In addition, more flexibility is permitted than use of a voting scheme, since voting schemes can only perform functions of the sort: 1 of n, 2 of n, k of n, etc. One of the advantages of performing a series of recommendations using fuzzy aggregation connectives over a simple weighted average is that they can model different levels of compensation between their input recommendations that cannot be achieved by the simple weighted average.

### BRIEF DESCRIPTION OF THE DRAWINGS

FIG. 1 is an illustration of the generalized mean, which is used as a fuzzy connective according to an embodiment of the present invention.

FIG. 2 is an illustration of a Gamma Model, which is used as a fuzzy connective according to an embodiment of the present invention.

FIG. 3 is a flowchart of the basic method according to the present invention.

### DETAILED DESCRIPTION OF THE INVENTION

The decision as to which programs a viewer will select or not select for watching is a human decision. When emulating the human decision making process (and fusing such decisions) it is advantageous to use methods that resemble the human decision making. The compensatory fuzzy aggregation connectives are proven to emulate well the human decision making process. They yield good results due to the tendency of humans to compensate attribute deficiencies of one aspect by stressing certain attributes of another aspect. By emulating the human decision process more accurate recommender scores can be obtained.

It should be understood that there can be many reasons to fuse recommendations. One scenario is that there are several recommenders for a given topic. This topic could be, for example, TV. Each of the recommenders uses different prior data to come up with the recommendation. E.g. first is an explicit recommender that bases its recommendation of the explicit interests that the user stated when filing a questionnaire. The second recommender is a TV recommender that uses user's viewing history to calculate the recommendations.

Another scenario is that both the first and the second recommender use viewers' viewing history as a base for making recommendations. However they use different methods for coming up with the recommendation (e.g. first uses a neural network, while the second uses a Bayesian engine).

The third scenario might be that the recommenders are TV recommenders developed for different people. Each recommender is based on one person's preferences. When those people want to watch together, one final recommendation is needed. This recommendation is obtained by fusing the recommendations from individuals.

In the present invention, the decision by a particular television recommender is defined as a degree to which the recommender predicts that the viewer will like to watch, or dislike to watch, any given television show.

Decisions are then combined together by fuzzy aggregation connectives. In particular according to the present invention, the fuzzy aggregation connectives selected to perform the fusion of recommenders are compensatory. Examples of compensatory fuzzy aggregation connectives are the Generalized Mean and the Gamma model, both of which are understood by persons of ordinary skill in the art. The Gamma Model is described in H- J. Zimmermann and P. Zysno, “Latent Connectives in Human Decision making”, in Fuzzy Sets and Systems 4, pp. 37-51 (1980), and the Generalized Mean is described in H. Dyckhoff and W. Pedrycz, “Generalized Mean as Model of Compensative Connectives”, in Fuzzy Sets and Systems 14, pp. 143-154, (1984), all of which are hereby incorporated by reference as background material.

The generalized mean and Gamma model connectives have the advantage in that they allow a position between the extremes on no compensation, which is characterized by the intersection operator, and full compensation, which is characterized by the union operator. In the first case, when no compensation among different sources (recommenders) exists, different features of the decision space are perceived from each source (recommender). Usually in recommendations based on several criteria (such as television program recommendations), a certain amount of compensation is desirable and therefore compensatory connectives will best describe the fusion process.

For example, when performing television program recommendations, one wants to take a position between the two extremes of no compensation (characterized by the intersection operator), and full compensation, characterized by the union operator. No compensation means that the information is complementary, and full compensation means that the information is redundant.

When no compensation among different information sources (recommenders) exist, different features of the decision space are perceived from each source. In recommendations based on several criteria, a certain amount of compensation is desirable, and therefore compensatory connectives will best describe the fusion process.

Fuzzy set theory is one approach for decision fusion/aggregation of evidence. For example, several connectives can be used for the purpose of aggregation in addition to the union and intersection. In traditional set theory, only union and intersection can be used for purpose of aggregation, whereas in fuzzy logic, compensative connectives have the property that a higher degree of satisfaction of one criteria can compensate for a lower degree of satisfaction of another criteria to another extent. The particular connective that one chooses depends upon the nature and relative importance or criteria, as well as the requirements imposed by the decision making process. The requirement may be that all the criteria be satisfied, or that any one of the criteria be satisfied. In the first case an intersection connective should be used, and in the second case a union connective. Described more fully below is a recommender method and system that uses fuzzy aggregation and fusion to provide a more accurate final recommendation to a user or users. It should be understood by persons of ordinary skill in the art that any compensatory operator can be used for fusion of recommenders. The choice of the particular connective depends upon the decision strategy to be adopted by a given application. The generalized mean and Gamma Model are each discussed below.

Generalized Mean

$$g ( {x}_{1} , {x}_{2} , … , {x}_{n} ; p , {w}_{1} , {w}_{2} , … , {w}_{n} ) = {( {\sum }_{i - 1}^{n} {w}_{i} {x}_{i}^{p} )}^{1 / p} \qquad ( 1 )$$

The generalized mean is defined by the equation:

wherein x₁'s are inputs, wᵢ's are weights (importance factors) and p is an exponent indicating a degree of closeness to the union/intersection operation. The smaller the p the closer the operation to an intersection. The larger the p, the closer the operation to a union.

The w₁'s can be the relative importance factors for the different criteria, wherein

$${\sum }_{i = 1}^{n} {w}_{i} = 1 ; \qquad eqn . ( 2 )$$

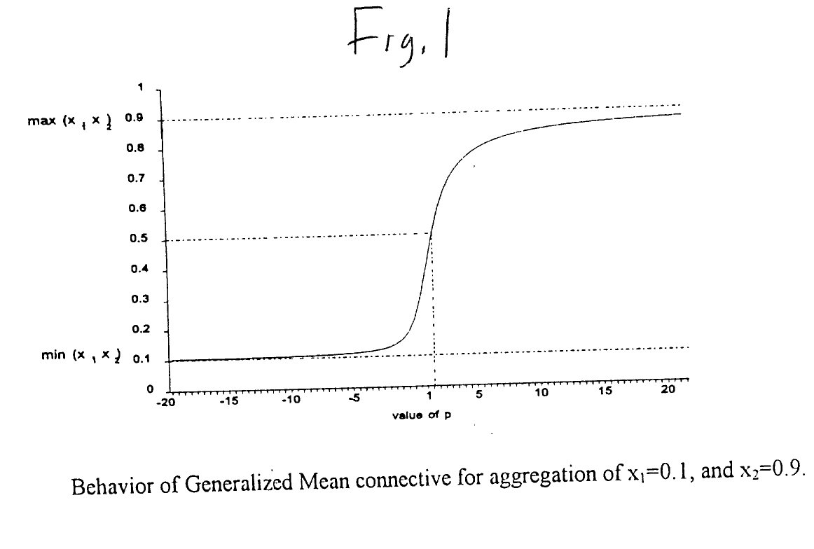

FIG. 1 is an illustration of the generalized mean, which can be used as one type of compensatory fuzzy aggregation connective in the recommendation system according to the present invention. The behavior of the generalized mean connective for aggregation of x₁=0.1, and x₂=0.9. The attractive properties of the generalized mean are:

min(a,b)<=mean(a,b)<=max(a,b);

mean increases with an increase in p; by varying the value of p between −infinity and +infinity wherein one can obtain all values between minimum and maximum. In extreme cases, the generalized mean operator can be used as an intersection or union. The rate of compensation for the generalized mean can be controlled by changing p

Gamma Model

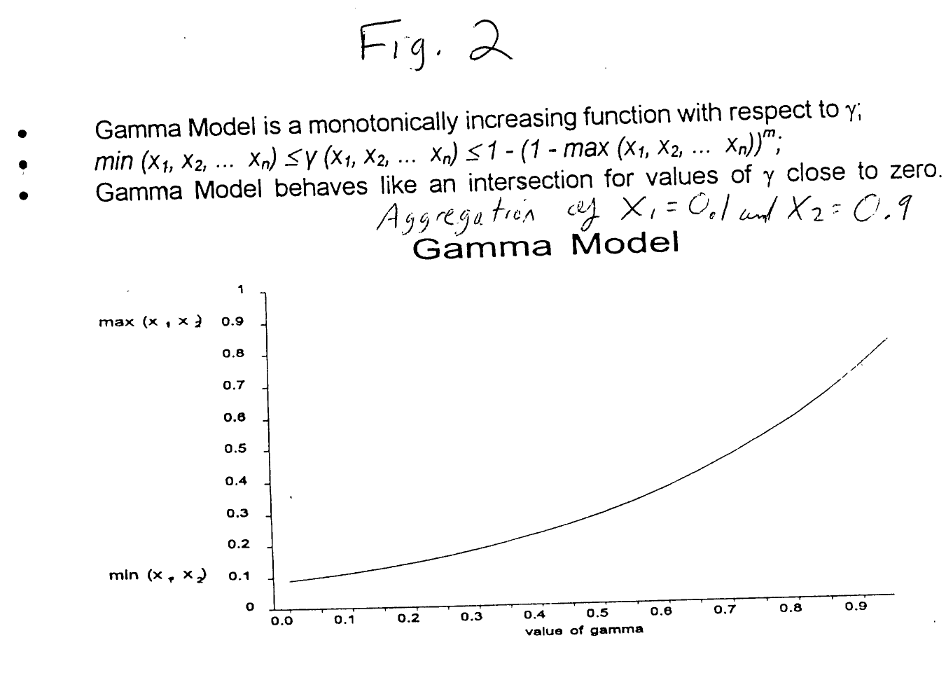

As shown in FIG. 2, the Gamma Model gives a closer match to human decision makers than other models in some situations. The Gamma Model is defined by:

$$y ( {x}_{1} , {x}_{2} , … {x}_{m} ) = {( {\prod }_{i = 1}^{m} {x}_{i}^{{δ}_{i}} )}^{1 - γ} {( 1 - {\prod }_{i = 1}^{m} {( 1 - {x}_{i} )}^{{δ}_{i}} )}^{γ} ; \qquad eqn . ( 3 )$$

where:

$${\sum }_{i\_ 0}^{m} {δ}_{i} = m , 0 \leq γ \leq 1. \qquad eqn ( 4 )$$

wherein:

xᵢ's are the inputs, and m is the number of inputs, γ is the degree of compensation. For γ=0 the Gamma Model becomes an intersection; for γ=1, the Gamma Model becomes a union. For values in between 0 and 1, the Gamma Model is a compensatory connective in between the intersection and union. The closer γ is to 0 the more “intersection-like” operation is performed; the closer γ is to 1, the more union-like operation is performed.

The Gamma Model is a convex combination of the product and the algebraic sum, which are known as algebraic representations of the intersection and the union, respectively. In equation (3), the inputs to be aggregated x₁ are from the interval <0,1>, δ₁ is the weight associated with x₁ and γ is a parameter that controls the degree of compensation between the union and the intersection parts.

For convenience, the intersection and the union part of the Gamma Model in FIG. 2 can be denoted by y₁ and y₂ respectively:

$$\begin{matrix}{y}_{1} = y ( {x}_{1} , {x}_{2} , … {x}_{m} ) = {( {\prod }_{i = 1}^{m} {x}_{i}^{{δ}_{i}} )}^{1 - γ} , and \\ {y}_{2} = {( 1 - {\prod }_{i = 1}^{m} {( 1 - {x}_{i} )}^{{δ}_{i}} )}^{γ}\end{matrix}$$

### EXAMPLE 1

Let's look at the following example that can represent how one family makes decisions. There is a husband and wife, and each of them has a separate recommender system for TV shows. On Monday night television, “Friends” is being shown on one channel, and at the same time on another channel an opera with Pavarotti is being aired. Which program will the system recommend more strongly for watching? Table 1 below provides some insight.

TABLE 1

| | | | | | | weighted | generalized |
|---|---|---|---|---|---|---|---|
| | husband | wife | w1 | w2 | p | average | mean |
| Pavarotti | 0.1 | 0.99 | 0 5 | 0.5 | 2 | 0.545 | 0.704 |
| Friends | 0.49 | 0.6 | 0 5 | 0.5 | 2 | 0.545 | 0.548 |

The recommendation scores for husband and wife are shown above in Table 1. The weighted average for both recommendations is the same 0.545.

Accordingly, the system must choose which show to recommend higher for viewing from between “Pavarotti” and “Friends” even though the weighted averages are equal. However, the generalized mean scores (with p=2) are different: for Pavarotti the generalized mean score is 0.704 (because one person liked it so much (the wife having a score of 0.99) that not watching it would be unacceptable), whereas for Friends the generalized mean score is only 0.548 (because both people were “warm” about the show, e.g. the husband and wife both had 0.49 and 0.6, respectively), without anyone person having a very strong opinion about the show. Thus, the more strongly one feels about the watching the program, the greater the value of the generalized mean (when p=2). Thus, according to the present invention, Pavarotti would be recommended higher than Friends.

An example of how another family makes a decision regarding the television show to watch is exemplified in Table 2:

TABLE 2

| | | | | | | weighted | generalized |
|---|---|---|---|---|---|---|---|
| | husband | wife | w1 | w2 | p | average | mean |
| Pavarotti | 0.1 | 0.99 | 0 5 | 0.5 | −0.5 | 0.545 | 0.2301 |
| Friends | 0.49 | 0.6 | 0 5 | 0 5 | 0.545 | 0.541 | |

The scores for Pavarotti, Friends for husband the wife are the same as previously shown in Table 1, and the weighted average is the same for each show. However this family likes the consensus style of decision making, i.e. they use to choose shows for watching that are not lowly rated by anybody. In this case the exponent p for generalized mean is 0.5, meaning that this is a more intersection based operation. The generalized mean result is a mere 0.23 for Pavarotti, and a higher 0.541 for Friends. Accordingly, the husband and wife will have Friends recommended much higher.

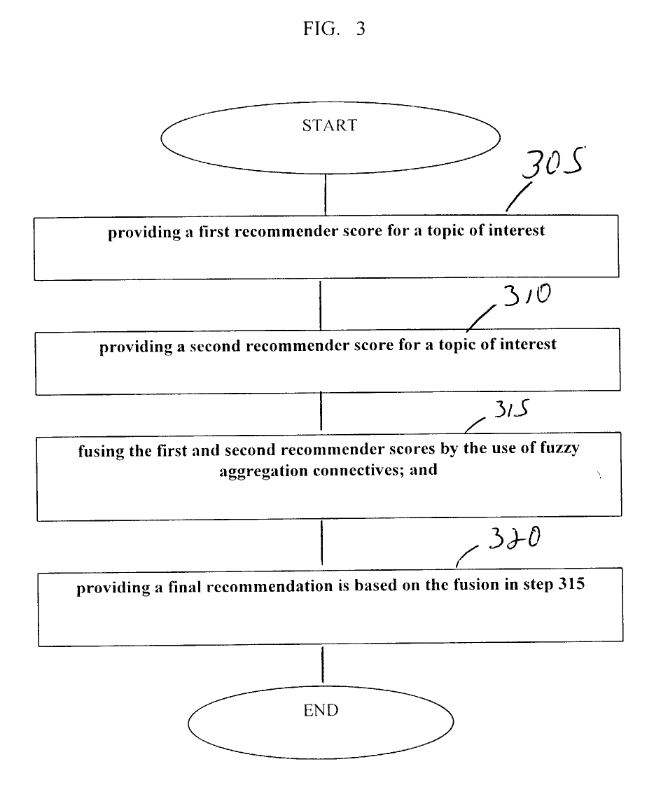

FIG. 3 is a flowchart providing an overview of the method of the present invention.

At step 305, there is provided a first recommender score for a topic of interest based on information on this topic such as TV viewing history; alternatively the first recommender score can be for the first person (like the wife and husband of our example). The topic of interest could be television, movies, music, books, restaurants, etc.

At step 310, a second recommender score for the same topic of interest based on a different set of information (such as movie going history) is provided. Alternatively, the second recommender score can be using the same set of information but a different recommender engine; Alternatively, the second recommender score can be for the second person (as in the previous example).

At step 315, the first and second recommender scores are fused by the use of fuzzy aggregation connectives. The type of fuzzy aggregation connectives can be Generalized Mean or the Gamma Model, to name a few.

Finally, at step 320, a final recommendation is provided from the fusion in step 315. Thus, a fusion by the use of fuzzy aggregation connectives provides a recommendation that can be greatly enhanced in accuracy, because, as explained in the previous example, there can be other factors involved in, for example, the preferences of two people watching television that cannot be factored into a voting scheme with any accuracy, such as the desire to find a consensus on finding a program that nobody greatly dislikes, even though a weighted average might indicate the same recommendation score for both. Quantifying these factors and fusing the first and second recommender scores using fuzzy aggregation connectives to provide a final recommendation is heretofore unknown, and provides for a more accurate depiction of human decision making.

It should be noted that various modifications can be made that would not depart from the spirit of the invention and the scope of the appended claims. For example, the items fused by fuzzy aggregation can be many other items than mentioned, including but not limited to sports, consumer purchases (such as clothes, electronics, jewelry, durable and non-durable goods). The actual method to perform the Generalized Mean or Gamma Model could have minor variations that would not depart from the spirit and scope of the claimed invention.

What is claimed is:

1. A method of fusing recommender scores, comprising the steps of:
(a) providing a first recommender score for a topic of interest based on one of a first set of information and a first method;
(b) providing a second recommender score for the topic of interest based on one of a second set of information and a second method;
(c) fusing the first recommender score and the second recommender score by compensatory fuzzy aggregation connectives; and
(d) providing a final recommendation for the topic of interest based on the fusion in step (c).

2. The method according to claim 1, wherein step (b) further comprises providing at least a third recommender score, and step (c) includes fusing said at least third recommender score with the first recommender score and the second recommender score.

3. The method according to claim 1, wherein the final recommendation is output on one of a display unit and a television set.

4. The method according to claim 1, wherein the compensatory fuzzy aggregation connectives used for fusing in step (c) comprises a Generalized Mean.

5. The method according to claim 4, wherein the Generalized Mean is determined according to the following equation:
$$g ( {x}_{1} , {x}_{2} , … , {x}_{n} , p , {w}_{1} , {w}_{2} , … , {w}_{n} ) = {( {\sum }_{i = 1}^{n} {w}_{i} {x}_{i}^{p} )}^{1 / p} \qquad ( 1 )$$
wherein xᵢ's are inputs, wᵢ's are weights (importance factors) and p is an exponent identifying a closeness to the operation of union/intersection of the inputs.

6. The method according to claim 5, wherein the wᵢ's are determined by the following equation:
$${\sum }_{i = 1}^{n} {w}_{i} = 1.$$

7. The method according to claim 4, wherein:
controlling a rate of compensation for the Generalized Mean by changing the value of p so that when a value of p is increased, the operation becomes closer to a union.

8. The method according to claim 1, wherein the compensatory fuzzy aggregation connectives used for fusing in step (c) comprises a Gamma Model.

9. The method according to claim 6, wherein the Gamma model is determined according to the following equation:
$$y ( {x}_{1} , {x}_{2} , … {x}_{m} ) = {( {\prod }_{i = 1}^{m} {x}_{i}^{{δ}_{i}} )}^{1 - γ} {( 1 - {\prod }_{i = 1}^{m} {( 1 - {x}_{i} )}^{{δ}_{i}} )}^{γ}$$
wherein
x₁'s are the inputs, δ₁ are the weights, and γ is the degree of compensation identifying a closeness to the operation of union/intersection of the inputs.

10. The method according to claim 9, wherein the weights are determined by the following equation:
$${\sum }_{i\_ 0}^{m} {δ}_{i} = m , 0 \leq γ \leq 1 ;$$
wherein:
m is the number of inputs.

11. The method according to claim 8, further comprising controlling a rate of compensation for the Gamma Model by changing the value of γ so that when a value of γ is increased, the operation becomes closer to a union.

12. The method according to claim 2, wherein the compensatory fuzzy aggregation connectives used for fusing in step (c) comprises a Gamma Model.

13. The method according to claim 10, wherein the Gamma Model determined according to the following equation:
$$y ( {x}_{1} , {x}_{2} , … {x}_{m} ) = {( {\prod }_{i = 1}^{m} {x}_{i}^{{δ}_{i}} )}^{1 - γ} {( 1 - {\prod }_{i - 1}^{m} {( 1 - {x}_{i} )}^{{δ}_{i}} )}^{γ}$$
where:
$${\sum }_{i\_ 0}^{m} {δ}_{i} = {m}_{i} 0 \leq γ \leq l .$$
wherein:
x₁'s are the inputs, and m is the number of inputs.

14. The method according to claim 1, wherein the first recommender score and the second recommender score comprise recommendations for one of television shows and movies.

15. The method according to claim 1, wherein the first recommender score and the second recommender score comprise recommendations for books.

16. The method according to claim 1, wherein the first recommender score and the second recommender score comprise recommendations for music.

17. The method according to claim 2, wherein the first recommender score, the second recommender score, and said at least third recommender score comprise recommendations for television shows.

18. The method according to claim 2, wherein the first recommender score, the second recommender score and the third recommender score comprise recommendations for one of books and music.

19. The method according to claim 1, wherein the first recommender score in step (a) is provided for a first person, and the second recommender score in step (b) is provided for a second person.

20. The method according to claim 2, wherein the first recommender score in step (a) is provided for a first person, and the second recommender score in step (b) is provided for a second person, and the third recommender score is provided for one of the first person and the second person.

21. The method according to claim 2, wherein the first recommender score in step (a) is provided for a first person, and the second recommender score in step (b) is provided for a second person, and the third recommender score is provided for a third person.
